(19) United States
(12) Patent Application Publication
(10) Pub. No.: US 2006/0124434 A1
(43) Pub. Date: Jun. 15, 2006

(54) Aerial conveyor with pendular arms driven along a closed loop circuit

(75) Inventor: Claude Fage, Salviac (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: Duerr Systems GmbH, Stuttgart (DE)

(21) Appl. No.: 10/532,092

(22) PCT Filed: Jan. 28, 2003
(86) PCT No.: PCT/FR03/00269

§ 371 Date: Jan. 23, 2006

Related U.S. Application Data
(60) Provisional application No. 60/420,657, filed on Oct. 23, 2002.

(51) Int. Cl. B62D 65/00; B65G 17/18; B65G 47/04

(52) U.S. Cl. 198/465.4; 198/474.1

(57) ABSTRACT

The invention relates to an air conveyor in a conveying assembly with two symmetrical conveyors for transporting car bodies resting on sleds individually suspended to traction carrier cables (60) through four independent pendle arms. The cables are synchronously driven to travel along parallel respective paths following a closed loop circuit in a vertical plane. The arms are affixed to the cables through articulated assembly devices enabling them to travel a complete revolution in the vertical plane. When they return empty, from the sled discharging station to the loading station, they are tilted along the cable until they rest on a support member integral therewith. A ramp is also provided for retaining the distal end of each arm which guides its tilting about an idler wheel when approaching the loading station.

The present invention relates to the conception and implementation of aerial conveyors such as those which transport objects along a factory line wherein these objects circulate sequentially through a treatment facility while they are individually suspended from one or more than one conveyors describing parallel paths, travelling from a loading station for the pick-up of each object by pendles or suspension pendle arms connected to the conveyor, until they reach an unloading station where they are released therefrom.

In a general manner, the invention aims at improving the conditions of operation of the robotized industrial sites involving such conveyors, especially by allowing high production rates thanks to better performance of the transport equipment in speed and in flexibility, while allowing a great robustness ensuring safety of operation together with reduced infrastructure investments and maintenance expenses. More precise purposes of the invention include, in particular, minimizing the space requirement of the installations, simplifying the procedures used at the loading station and at the unloading station, promoting construction parameters and operating conditions that ensure great durability while preventing the wear of the moving parts.

The invention relates more precisely to the conveyors intended for installation facilities in which the objects are transported while suspended by pendle arms from two symmetrical conveyors which travel through the installation under the control of synchronized driving means, while concerning yet more particularly, although in a non limiting manner, those implementations in which each load is suspended on the two conveyors on the one hand at its front, on the other hand at its rear. It is admitted here that each load may consist directly of one of the objects to be carried, but that it may also consist of an assembly comprising that object and an appropriate support on which it rests, the support being in particular chosen to be compatible with the conveyors, in particular with the pendle arms that they comprise.

Installations of the kind concerned by the invention are common, in particular, in car manufacturing plants. A particular feature of such systems is that the objects transported, especially when dealing with car bodies, are both heavy and bulky units. Probably at least partly for that reason, the conveyors most frequently used in this kind of installation are chain conveyors, in which the pendle arms are affixed with articulation to the links of a chain travelling in translation on itself through the installation, along a travel path that is strictly defined by guide rails whose essential role is to support the weight of all the mobile elements. Accordingly, the articulation shafts or pins of the successive links of the chain are terminated by rollers which run captive in the guide rails during the movement of the chain.

However, substantial technological improvements are provided if such chains are abandoned in favor of cables playing the role of traction or motive means entraining the pendle arms for suspending the objects, particularly when, in addition, said cables act as carrying means for the transported loads, as is proposed in a parallel patent application filed same date and form as the present application, in the respective names of the same inventor and the same applicant company. In the context of the preferred applications of the invention, the loads then consist of car bodies each of which rests on a support usually called a sled because it essentially consists of two parallel longitudinal beams, or so-called skids. The sleds are used to support the car bodies for carrying them through other production units, optionally equipped with ground conveyors, and to transfer them from one conveyor to another, whether they be conveyors on the ground or conveyors in the air like those according to features specific to the present invention.

Irrespective of the choice of the traction motive means, that where appropriate will also be carrier means, it is known that, according to the needs of each particular application, there exist various solutions relating to how the circulation of the load suspension arms is organized. Considering more specially, as a typical example, the case of transporting car bodies in an assembling or painting line facility, there are thus, in particular, implementations wherein each body is suspended by two pendles, placed one at the front and the other at the rear in the direction of transport and each being formed in a single piece thanks to a transverse bar fixedly attaching two vertical arms connected respectively to the traction means of the two conveyors, and there are implementations where the arms of the pendles are no longer connected in a rigid assembly and each load to be conveyed in the installation, following a predefined conveyor line, is suspended on two symmetrical conveyors by four independent pendle arms, two per conveyor.

Also, the invention is of particularly significant value in the cases where, in order to avoid having to provide devices for the engagement and disengagement of the load suspending arms at the loading and unloading stations at the ends of the conveyor line, these arms are mounted permanently, in fixed positions regularly distributed on the traction means of the conveyor or conveyors, and where these traction means are driven in translation on themselves along a closed loop circuit, comprising a forward circuit portion travelling along the conveyor line from the loading station to the unloading station and a backward circuit portion wherein the load suspending arms are empty and circulate to return from the unloading station to the loading station for picking up a new load there. In addition, and although it be in a non limiting manner, the invention lends itself particularly well to situations that involve such a closed loop circuit situated entirely in one same vertical plane and in which, furthermore, the portion for the return of the arms empty is disposed, in this plane, above the forward portion which transports the loads along the conveyor line.

Furthermore, the air conveyors of the type in question in the context of the present invention are particularly appreciated for transporting the car bodies along circuits involving inclined sections, when in particular the bodies have to be dipped in treatment baths in tanks as is encountered in phosphatization paint lines or cataphoresis or other electrolytic treatment lines, due to the fact that the circuits followed by the traction means of the conveyors comprise changes of incline slope in a vertical plane, hence the value of closed loop circuits remaining equally totally in one and the same vertical plane. Specifically, it is desirable that, throughout their whole path, the traction means work in zones having curves always in the same plane. This technological requirement is particularly sensitive when the traction means are cables kept tensioned on guide wheels between which the loads are exclusively carried by the cable or cables via the arms providing their suspension.

In the installations of the afore-mentioned type, whether they be with one or two conveyors, in which the loads to be transported are carried individually suspended, each by at least one pendle arm, on traction means to which the arms are attached in fixed positions regularly distributed and which are driven in translation on themselves to describe a closed loop circuit, the invention applies essentially to equipping the conveyor, or each conveyor of such an installation, with means of controlling the orientation of the arms throughout the length of this circuit.

More precisely, while in a forward portion of the circuit along the line for conveying said loads, from a loading station to an unloading station, the suspension arms are hanging vertically under the effect of the weight of the loads, the invention makes provision for organizing their circulation in such a manner that, when they return empty from the unloading station to the loading station to pick up a new load there, they are oriented in a position in which they are individually tilted along the circuit of the traction means, in its so-called return or backward portion, advantageously until they come to rest on receiving members fixedly attached to said traction means.

In its preferred embodiments, the invention also provides means by which, during a complete travel around the closed loop circuit, each arm is required to execute a complete rotation in space, by rotating through a half-turn about its proximal end at which it is connected to the traction means, between the moment when it is hanging vertically at the exit of the unloading station and the moment when it is again hanging vertically on its arrival at the loading station. Each arm is accordingly attached to the traction means, at its end here called proximal, by an articulated assembly device allowing it to pivot freely in the vertical plane of the path of the traction means, about an articulation shaft or pin perpendicular to this plane. In a more particular manner, the various arms for suspending the loads are guided at a distal end some distance from said proximal end, to conduct their swinging rotation about the articulation pin of the respectively associated assembly devices, from their orientation in a position tilted along the circuit in its backward portion until they are again in a position hanging vertically when approaching the loading station.

In the context of the preferred embodiments of the invention, it is not only that the circuit of the traction means is situated entirely in one single vertical plane, but also, the backward circuit portion returning the empty arms back runs above the forward portion for conveying the loads. The benefits of the invention are then particularly marked with respect to savings in space and infrastructure works. The rotation of the arms is advantageously provided by a pivoting movement of each arm (about the articulation pin of the assembly device between suspension pendle arms and traction means) through substantially a one-quarter turn at the exit of the unloading station, to pass from the vertical orientation to the orientation in a position tilted along the circuit, preferably substantially horizontal (the distal end being held back relative to the proximal end), and by a swinging rotation movement of each arm, in which its distal end passes over its proximal end, while describing a three-quarter turn, on the approach to the loading station.

It should be noted that, at this stage of the definition of the invention, it is of little importance whether the carrier tractive means moved on themselves to describe a closed loop situated in a vertical plane are cables or tractive chains associated with carrier rails. For convenience of language, use will be made hereinafter of the preferred case in which it is question of carrier cables kept tensioned along said circuit by guide wheels as is described in the parallel patent application already mentioned, but it must be understood that the main features of the invention would apply as well by the same means used to achieve the same result, if the cables were replaced by chains associated with carrier rails.

In a similar manner, the invention will be described with reference to a loading station and an unloading station being disposed relative to the organization of the circulation of the arms according to the secondary features of the invention, in its preferred embodiments, but it must be accepted that its main features would be just as valid if the functions of the loading station and of the unloading station were inverted at the two ends of the transport loop. It also enters into the context of the present invention to suspend the loads to be transported indifferently on a single conveyor or on two symmetrical conveyors situated in parallel vertical planes, as well as to provide one, two or four independent arms for each load, when the arms remain articulated in fixed positions regularly distributed over the traction carrier means and that the loads are individually picked up at the loading station to be deposited at the unloading station.

Various features of the invention relate to the implementation of the traction means of the conveyor, or of each conveyor, in association with the support members receiving the pendle arms in their tilted position and with the guide means controlling their rotation from this position.

Thus, the invention makes provision advantageously to form the traction means carrying the loads, in each conveyor, by two coupled cables, between which lie the assembly points of the pendle arms, the coupling between the two cables being provided, at each pendle arm, by the assembly device of the latter, which clamps onto both of the cables by two grips situated at the ends of the articulation pin. Along the forward portion of the circuit followed by the cables, the arms are hanging between the respective guide wheels of the two cables. The members for receiving the arms traveling backward in the tilted position may consist of these assembly devices, or of different members that are as well secured to the two cables between them. These members are advantageously disposed so as to push the arms leaving the unloading station causing them to incline forward. At the other end of the installation, a ramp is advantageously provided for retaining the arms during their swinging rotation which is preferably formed so that they reach the loading station in an orientation inclined rearward until they are left freely hanging vertically when picking up the sled to be loaded. These dispositions ease considerably the conditions of loading and unloading the sleds.

Further features and advantages of the invention will appear when reading the following description of preferred embodiments of a transport assembly with two symmetrical conveyors according to the invention, in its application to the transportation of sleds supporting car bodies in a treatment line facility in the car industry.

This description is made with reference to the drawings that it comprises, in which:

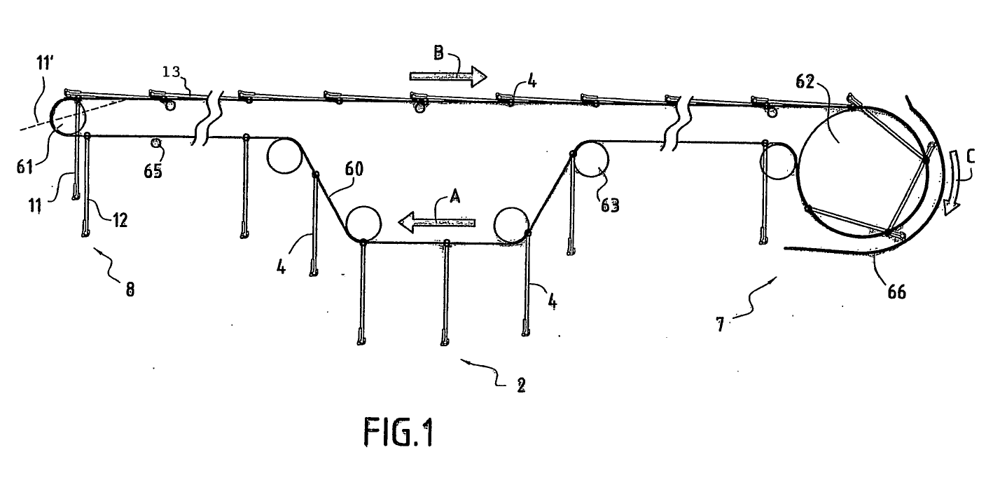

FIG. 1 represents in a very schematic general manner, a side view of the circuit to which the pendle arms for suspending the sleds in one of the conveyors;

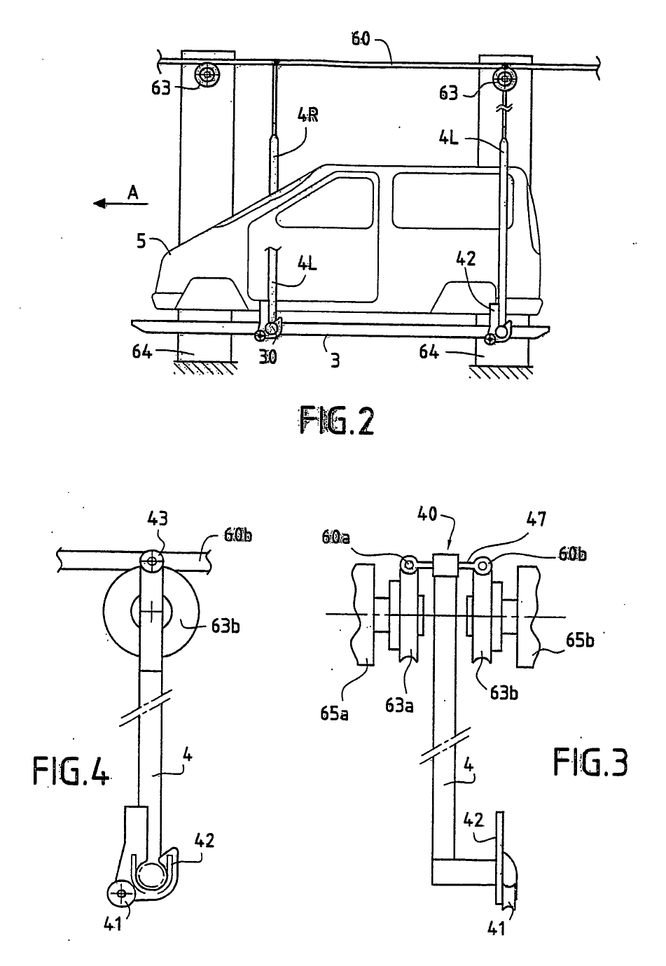

FIG. 2 is a schematic representation in side view relative to the conveyor line showing a car body on its sled during transport;

FIGS. 3 and 4 illustrate more particularly a pendle arm while passing over the guide wheels of the two coupled cables of a so-called “dual-cable” conveyor, respectively in front view transverse to the conveyor line and in side view longitudinally;

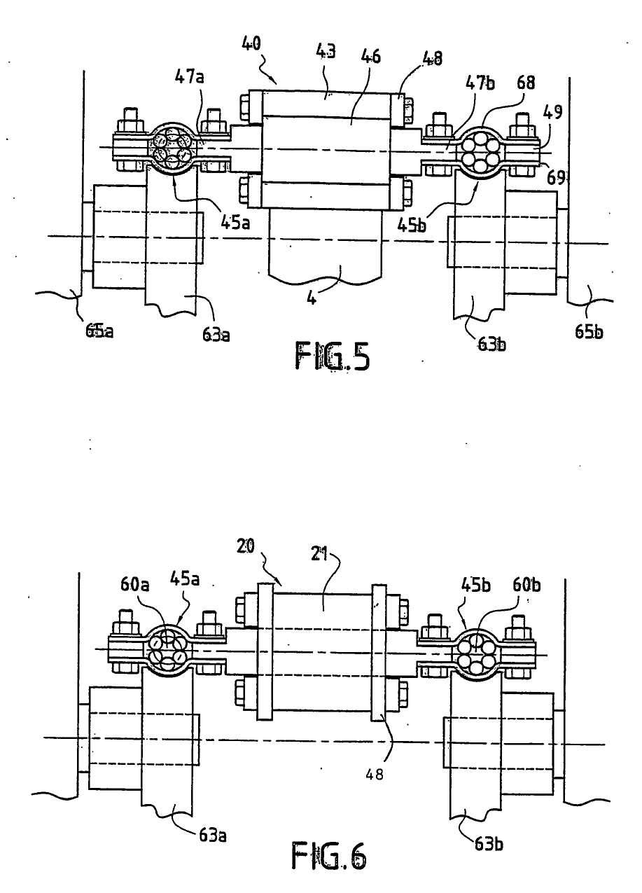

FIG. 5 shows in a more detailed manner as an example of a preferred mode of assembly, the device used for the articulated attachment of a pendle arm to the corresponding cable;

FIG. 6 shows with the same scale a member for receiving a pendle arm in backward tilted position, as attached to the two cables of a dual-cable conveyor

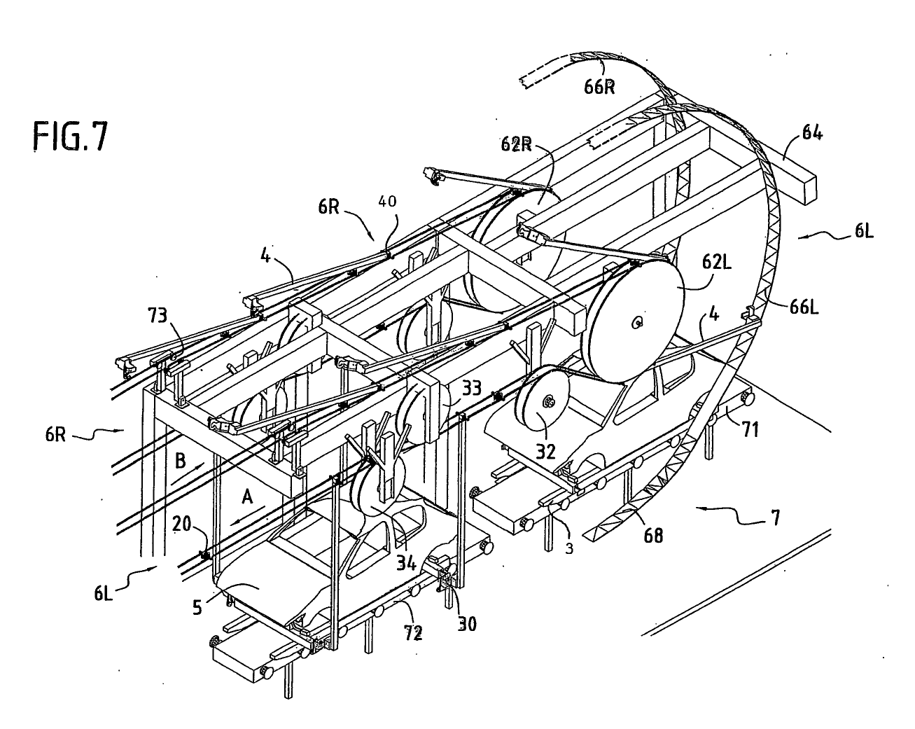

FIG. 7 is a view in perspective of the installation described, as extracted from a computer-aided design electronic file, showing especially a drafted practical embodiment of the installation at the loading station;

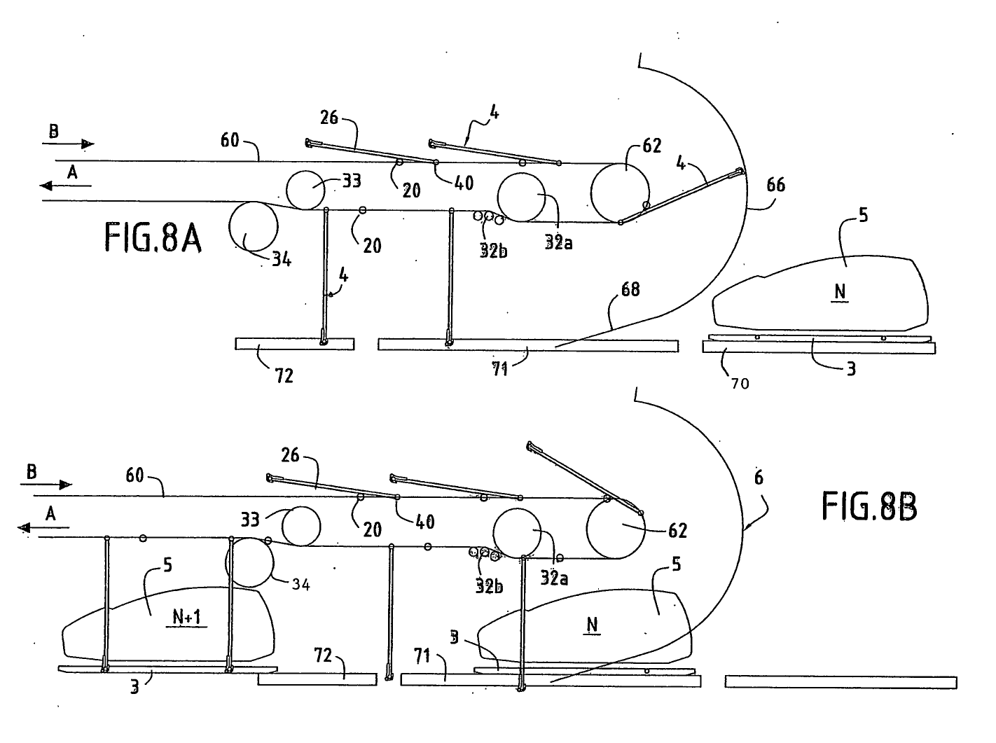

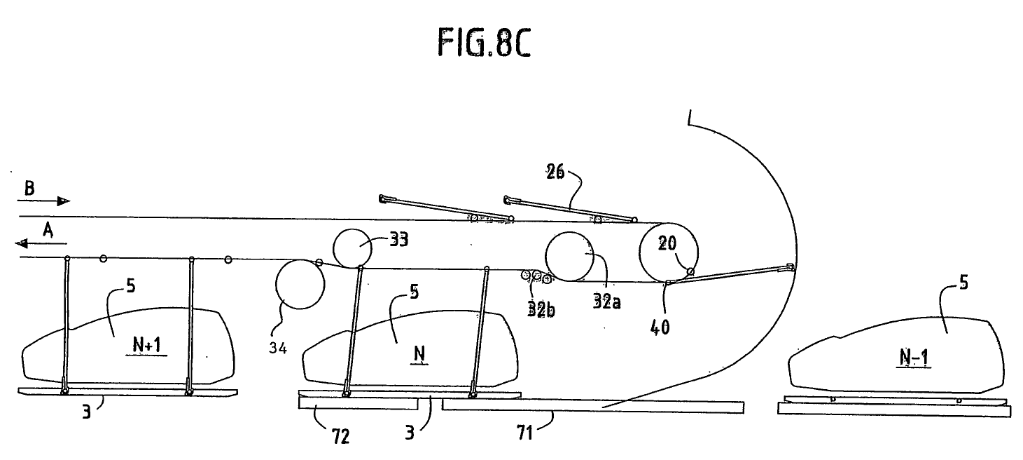

FIGS. 8A, 8B, 8C illustrate schematically the transfer of a body from a conveyor line on the ground at the loading station;

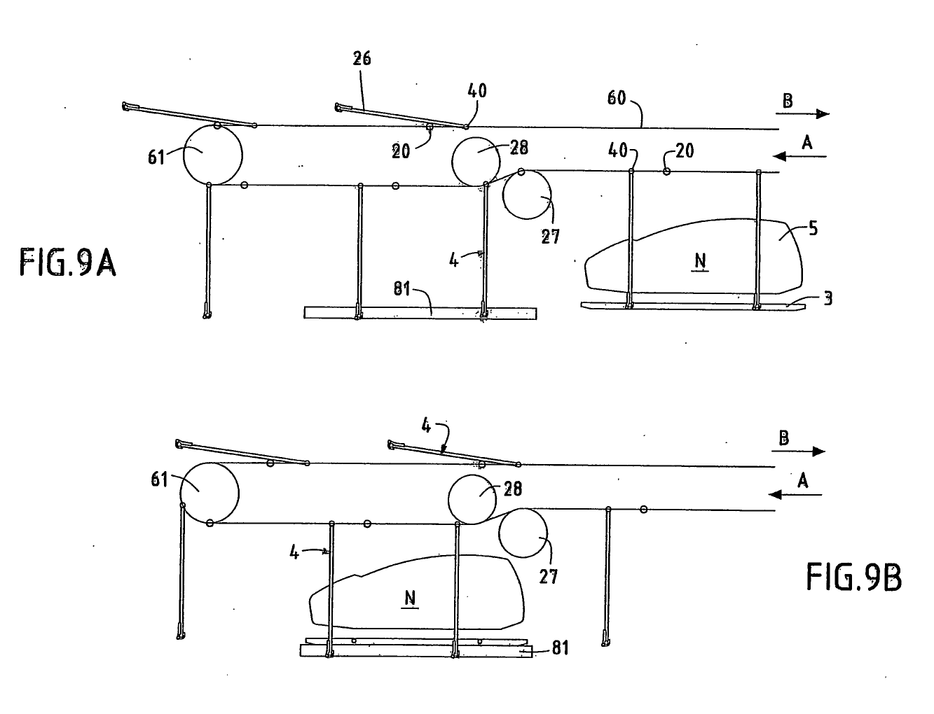

FIGS. 9A and 9B illustrate symmetrically the transfer of a load leaving the installation, on a conveyor line on the ground, where it is picked up by roller tables.

In the preferred embodiment of the invention described here, consideration is given to an installation with two air conveyors symmetrical relative to the vertical mid-plane of the installation. The two conveyors operate in a synchronized manner to carry through the installation, along the conveyor line (arrow A in the figures), bodies 5, each resting on the support which it is agreed to call a transport sled 3, to which four independent suspension arms 4 are attached, also numbered 4R on the right and 4L on the left when looking in the direction of movement of the bodies during treatment on the conveyor line.

In a conventional manner per se, the sleds 3 are used to transfer each of the various bodies to be treated sequentially between successive conveyors. Thus, at the entrance of the installation, each body with its sled is picked up from a conveyor on the ground situated upstream, illustrated in FIG. 8 by two roller tables 71 and 72. Conversely, at the exit of the installation, the sled with the body that it carries is deposited on another conveyor on the ground, or downstream conveyor, which is usually also of the roller table type.

In each conveyor, the pendle arms 4 are distributed regularly, at equal distances, and freely hanging from cables 60. As also shown in FIG. 1, each cable 60 is driven in translation on itself to describe a loop which closes on itself in a vertical plane at each end of the installation, on the one hand at the loading station 7, on the other hand at the unloading station 8. The driving means that provide the drive of the cables is not shown. They may be of any type known per se. They are preferably implemented as is described in the aforementioned parallel patent application, in order to synchronize the two conveyors in speed, while also providing, in position, a precise correspondence between two counterpart arms 4L and 4R which must be aligned on the same transverse line perpendicular to the plane of the circuit.

The cables 60 are made up, in a manner conventional per se, of a plurality of bundles wound in a helical spin about a central core, each bundle advantageously being itself formed of several bundles of metal wires spun together. Before the installation is started up in normal operation for the transport of the loads, the cables need to be subjected to a progressive tensioning procedure during which they are lengthened. Once this procedure is terminated, they remain tensioned practically without lengthening further. In the context of the present invention, use can be made in particular of the cable tensioning means which are described in the parallel patent application cited above. They act in traction on the cable drive wheels, situated on the unloading side of the installation. They maintain a permanent traction force to stretch the cable during the operation of the installation and prevent it from taking on an inconvenient sag beneath the weight of the loads transported.

The circuit imposed on the pendle arms is defined by guide wheels 63, distributed along the installation. Such guide wheels are in particular sometimes above, sometimes below the path of the cable, where inclined portions must be imposed, as is the case when the bodies must be dipped in treatment baths, which is illustrated by an item 2 in FIG. 1. On the rectilinear portions of the circuit, the guide wheels may be reduced to simple rollers or castors 65 of small dimensions. Between two guide wheels, or groups of guide wheels, the loads are carried exclusively by the cables. FIG. 2 thus illustrates a body and its sled entirely carried by the cable 60, between two guide wheels over which it passes, via two successive pendles 4.

Among the guide wheels of the cables, those that are at the ends of the installation should be marked out. They form the return wheels 61 and 62 which conduct the cable round a curve through 180 degrees, from its path in the direction of the arrow A, along the line for conveying the loads representing the forward portion of the circuit, to its path in the direction of the arrow B (FIG. 1), along the return portion of the circuit, and vice-versa. In addition, at the unloading station 8, the return wheel 61 also plays the role of drive wheel, to pull the cable along the forward portion of the circuit, active in transport of the loads, from the installation exit end. It is also at this end that the tensioning means are placed which, in addition, push the rotation axle of the wheel 61, to subject the cable to a traction force tending to lengthen it. At the opposite end, corresponding to the loading station 7, the return wheel 62 is mounted to rotate freely on a fixed framework supporting the whole installation. The same applies to the other cable guide wheels which are not drive wheels. For the wheels 63 in FIG. 2, the fixed framework is illustrated by vertical uprights 64 at the top of which the wheels 63 are free to rotate about a horizontal axle perpendicular to the path followed.

Supplementally concerning the definition of the complete circuit followed by a cable 60, FIG. 1 shows the path of each cable, which travels through the installation first following the conveyor line from the loading station 7 to the unloading station 8, to then return from the unloading station 8 to the loading station 7, to bring back the pendle arms circulating empty after having deposited a sled at the unloading station in order to pick up another one at the loading station. At its most simple, this return circuit is direct, substantially rectilinear in the horizontal direction. Furthermore, in the vertical plane of the circuit, it is placed above the forward circuit portion. FIG. 1 also shows that the arms 4 returning empty are tilted down on the cable, and it illustrates schematically a ramp 66 which holds their fall when they rotate around the return wheel 62 of the loading station.

The schematic representation of FIGS. 1 and 2 shows only one cable for each conveyor. But in practice, at least in the embodiment chosen to best illustrate the invention, the two conveyors are of the dual-cable type, that is to say that they comprise two parallel cables to which the various pendle arms are assembled. This is used to better carry the weight of the loads by distributing the forces, and consequently to make full use of the advantages that the structure of the cables brings, when, as here, they form both traction and carrier means for the loads. The figures that will now be described show that, in addition, the two cables of each conveyor are coupled together via devices which provide the articulated connection of the pendle arms.

As can be seen in FIGS. 3 and 4, each pendle arm 4 is attached to the two parallel cables 60a and 60b of the conveyor to which it relates, at its so-called proximal end, which corresponds to its top end when it circulates hanging vertically along the forward path of the conveyor line. The attachment is provided by an articulated assembly device 40, whose articulation pin is here in the form of a rod 47 swiveling in a pivot race 43 at the head of the arm and extended by grips which are firmly clamped onto the cables. This assembly leaves the arm 4 fully free to pivot in the vertical plane of the circuit, when it is not retained in another manner as will be seen hereinafter.

The arm 4 is shown at the moment when it passes over the guide wheels 63a and 63b, in a sheave groove which prevents it from straying sideways from its normal path, without for all that restraining its longitudinal movement on itself. These wheels are mounted freely rotating on themselves, about their respective pins, on fixed beams of the installation, 65a and 65b. A sufficient spacing is provided between the wheels 63a and 63b facing one another, so as to allow the pendle arms 4 to pass freely hanging between them, without impact or friction.

At the bottom portion, at its distal end relative to the cables, each pendle arm 4 is made up so as to form a hook 42, constituting a grab hook for an interacting handle provided on the sleds. With a spacing equal to the pitch separating two successive arms of each conveyor, each sled 3 comprises two handles 30 on each side (see FIG. 2), respectively on the two longitudinal skids of the sled, at the ends of crossmembers linking the two skids in a rigid assembly. In a nonlimiting manner, in the particular case described here, hooks 42 opening rearward have been chosen, as shown in FIG. 4. They engage with the handles 30 of a sled 3 at the loading station 7, beginning by placing themselves in front thereof, and they are released therefrom via the rear at the unloading station 8. A slight upward or downward movement respectively ensures a latching or an unlatching of the two pieces.

Furthermore, at the end of each arm 4, a roller 41 is provided whose essential role is to interact with the ramp 66 when the arm rotates about the return wheel 62 of the loading station. It is observed that this roller 41 is placed laterally on the hook 42, overlapping the latter and on the inside relative to the conveyor line and that the hook 42 itself is offset on the inside relative to the rest of the rectilinear bar forming the main portion of the pendle arm. Specifically, as is clearly shown in FIG. 3, the implementation of dual-cable conveyors as described here lends itself particularly well to an installation using so-called narrow sleds. In this case, the arms 4 pass round the outside of the body being carried and return to the handles of the sled, which are disposed in a recessed manner beneath the body. Thanks to the flexibility of the two cables, which are acted upon in the inverse direction, and to the symmetrical disposition of the two conveyors, the bars of the pendle arms nevertheless remain vertically oriented plumb with the associated assembly devices.

The device providing the pivoting assembly of the arms on the cables and the coupling of the two cables of one and the same conveyor appears in greater detail in FIG. 5, where an arm 4 can be seen hanging between two wheels 63a and 63b, free to rotate on fixed framework elements, illustrated by the beams 65a and 65b. At the head of the arm 4, the device comprises a race 43, in which a pin 46 swivels and which is held laterally by mounting collars 48. The race 43 forms a rolling bearing cage of horizontal axis perpendicular to the line of transport and centered in the plane of the coupled cables. Either side of the race 43, the rotary pin 46 is extended in two opposite legs, 47a and 47b respectively. At the end of each of them there is a grip clamped onto the corresponding cable. Each grip 45a or 45b is, in practice, formed of two jaws 68 and 69, one above the other, which are clamped tight against the cable, on one side on the leg extending the race 43 of the articulated mount, and on the other side on a thickness spacer 49. In manufacturing practice, the latter is advantageously cast in a single piece with one of the pieces forming the jaws of the grips, for example by steel pressure injection.

FIG. 1 supposes that the assembly devices that provide the coupling of the cables are built to be able also to play the role of the support members receiving the arms circulating empty, in their tilted down position. Accordingly, the race in which the articulation pin swivels is modified to facilitate a sliding or rolling contact with the preceding arm when the latter comes to bear thereupon, by its own weight. The figure shows an arm 11 at the moment when, the corresponding assembly device having terminated its curved path on the return wheel 61 (thus executing a half-turn, through 180 degrees), it butts via its own free end against the head of the following arm 12, which arrives at the bottom of the wheel. It represents the same arm at 11′, in a dashed line, when subsequently, it inclines forward as a result, pushed by its support member, before being practically horizontal on the cable 60 (like the previous arm 13 in the figure), once the following arm 12 itself also arrives at the top of the return wheel 61.

In the more elaborate embodiment of the installation with two dual-cable conveyors, the support members 20 receiving the arms in the tilted position are distinct from the devices 40 providing their articulated assembly. They are also placed, as shown in FIG. 7 and following, at a distance behind the articulation pin of the arm in the direction of circulation.

Each of these support members 20 is made as is shown in FIG. 6. It forms, like the articulated assembly device, a coupling member between the two cables 60a and 60b. Accordingly, it comprises the same grips 45a and 45b that are seen in FIG. 6 at the moment when they pass over the guide wheels 63a and 63b. On the other hand, the pin that connects the two grips no longer carries an articulation piece forming the head of a pendle arm but a roller 21 free to rotate about this articulation pin. The rotary roller 21 is provided to ensure a rolling contact with the bar forming a pendle arm 4. It is held between two mounting collars 48, as hereinabove for the articulated arm head 40.

A description will now be given of how the loading and unloading stations are formed at the ends of the installation and the operation of the means of transferring the sleds carrying the bodies during treatment from a conveyor on the ground upstream at the entrance of the air conveyor installation and toward a conveyor on the ground downstream at its exit. The two conveyors on the ground are taken to be of the roller table type, these tables being numbered 70, 71, 72 for the loading station (detailed implementation in FIG. 7 and FIG. 8), 81 for the unloading station (FIG. 9).

It will be seen that in both cases, in both of the load transfer stations, the conveyors overlap by a length corresponding to the total of two sled modules during transport, hence four times the distribution pitch of the pendle arms on the cables, and that the conveyors on the ground are there fitted with means of varying the drive speed of the sleds. Conjugated with a cable path which causes the hooks to descend beneath the handles of the sleds on the approach to the station in order to raise them thereafter, this speed variation is used to ensure the hooking and unhooking of the pendle arms without it being necessary to have to use lift or lower devices.

The detailed implementation in FIG. 7, which shows the successive arms in different positions at the loading station, has the advantage of clearly illustrating the make-up of the front and rear pendles for suspending the loads via four independent suspension arms and the joint behavior of the two conveyors, 6R on the right and 6L on the left. It also represents the two ramps 66R and 66L which are respectively associated with each of the two conveyors. Each one is formed so as to not only prevent a sudden fall of the arms, but also to hold them in a rearward inclined position long enough to make them pass without difficulty at a distance from the elements of the roller conveyor until they are brought into hooking position in front of the handles of a waiting sled on the approach to the station.

FIG. 7 also shows that, for each conveyor and for each cable of each conveyor, the return wheel such as 62L or 62R is supplemented by a wheel or castor 32, of smaller diameter, whose relative disposition is such that the head of an arm 4 at the level of the articulated assembly device is caused to descend before rising in two steps to the level of the forward circuit of the conveyor line (arrow A for the left conveyor). When the cables rise again from the low point of the return wheel (62L or 62R) to the high point of the castors 32, the arm passes between the two castors 32 and returns to hanging vertically, raised to a level such that the hook 42 at its distal end is placed presenting its opening at the height of a sled handle 30, plumb with the latter, for a sled then resting on the conveyor on the ground upstream, on the roller table 71.

The figure then shows two pairs of guide castors, reference numbers 33 and 34, which again impose a slight raising of the arms. By thus passing first beneath the castors 33 and then between the castors 34, each arm pulls its bottom hook in its lifting movement, which causes the hook to latch onto the sled handle that has encountered it. The sled 3 is thus picked up and carried off the roller table 72. Note that the length of the section of intermediate circuit from which the pendles pick up the sleds covers a complete module of the transport line.

As incidental features of the installation chosen to illustrate the invention at its best, the same FIG. 7 illustrates an embodiment of the fixed framework 64 supporting the various elements, in a representation in perspective which is self-explanatory. It also shows that this framework supports rollers 73 which are sufficient to guide the cables when, in their return path from the unloading station to the loading station (arrow B), they no longer carry the sleds 3 with the vehicle bodies 5, but only the pendle arms 4.

The operation in the attachment of the sleds at the loading station emerges better from the FIG. 8, with reference to the pendles 4 as comprising the two symmetrical lateral arms. FIG. 8A shows a load of the order N (body 5 on its sled 3) on the approach to the loading station. The conveyor on the ground is stopped. The pendles 4 which are to seize it are driven by the air conveyor (cable 60) which successively brings the front pendle then the rear pendle up to the bottom portion 68 of the ramp 66 where it is then raised a first time when the cable is being guided by the group formed of the wheel 32a and the castors 32b (which replaces the castor 32 in FIG. 7). In FIG. 8B, the front pendle has already risen and the rear pendle is on the point of doing so, the assembly then being in the position that is illustrated in FIG. 8A for the previous pendles 4 (the load N+1 not being shown), with their hooks level with the sled handles. At the same time, the conveyor on the ground carries the load N more quickly than the pendles, until the handles are placed in front of the pendles intended to seize them. From the moment when the handles engage in the pendle hooks, the latter tend to incline as shown in FIG. 8C. This causes the hooking and latching. The speed of operation of the conveyor on the ground is then returned to the same value as that of the cable 60, while successively the front pendle then the rear pendle are raised a second time on passing the wheels 33-34. The load is thus released from the table 72 and carried away by the air conveyor.

In connection with the fact that the hooks are placed in front of the sled handles, the implementation of the unloading station is simply a step of changing the level of the hooks terminating the pendles 4. According to FIGS. 9A and 9B, which illustrate two positions characteristic of a load of the order N, this change of level occurs due to the presence of pairs of guide castors 27-28 which, on the path of each cable, precede the return wheels 61 (drive wheels) by a length covering a complete module of the transport line.

In FIG. 9A, the load reaches the station while the conveyor on the ground is stopped. It remains driven until taking the place of the previous load on the roller table 81. When the corresponding pendles 4 descend one after the other on the intermediate circuit section while passing over the castors 27-28, it comes to rest fully on the rollers after being inclined slightly. The conveyor on the ground is at this time slowed, if not stopped, to allow the hooks to release from the sled handles (it being understood that they are brought for this purpose to descend to a level below the pin of the handles). The pendles are then taken around the return wheel 61 while the conveyor on the ground starts again to clear away the load without the sled being hampered by the hooks of the pendles.

When the drive cables rotate around the wheels 61, the pendle arms 4 incline progressively forward due to the fact that they butt against the support members 20 which follow them on the cables, whereas they are free to rotate about their device of assembly to the cables 40, without following the movement of the grips themselves. They are then in the inclined position on the cable 60 illustrated at 26 in the figures.

The operation here is therefore different from what happens at the loading station. The pendles rotate in opposite directions about their articulation pins on the cables, while they perform in total a complete rotation in space. In the loading station, the arms 4 whose head circulates with the cables about the return wheel 62, tilt about their respective articulation pins while deploying outside the wheels. At the unloading station, the rotation of each arm in space is substantially through a quarter-turn, in the leftward rotatory direction, to pass from the position hanging vertically at the exit of the unloading station to the tilted position on the cables. At the loading station, it is through a three-quarter turn, in the rightward rotatory direction, to pass from the horizontal orientation tilted along the cables to the vertical orientation at the loading station. Hence the value of the retention ramps, such as the ramp 66 in FIG. 1.

It should be remembered in particular from the operation that has just been explained that, at the two ends, the air conveyor installation according to the invention overlaps, with the upstream conveyor at the loading station on the one hand, with the downstream conveyor at the unloading station on the other hand, over a length covering a complete module of the transport line, where the sled is between the return wheels, fully suspended by the pendle arms which are on the same section of circuit where they are free of all guidance. In addition, at these two ends of the installation, the path of the cables causes the heads of the pendle arms to descend to a sufficiently low level for the hooks to present their opening at the level of the interacting handle of a sled which still rests (at the loading station) or which already rests (at the unloading station) on a ground conveyor roller table. Furthermore, the effects of the return wheels and those of the castors for guiding the cables that follow them or precede them on the circuit work together with those of the retention ramp on the one hand, of the support members on the other hand, to control the rotation of the arms so as to facilitate the interactive operation of the hooks with the corresponding handles, but also to control their movements flexibly and safely.

It is observed finally that the flexibility of the cables used as carrier and traction means here plays an important role, in particular to balance the sled on its four suspension arms at the moment when the front ones then the rear ones pass over the change-of-level castors which cause the raising of the sled picked up at the unloading station or respectively its lowering to deposit it at the unloading station.

However, the same kind of advantageous operation would be found in various variants of the particular embodiment hereinabove which form part of the invention. In particular the dispositions relating to the elements could be inverted between the two end stations of the installation or a hooking of the sleds could be provided by pendles with hooks oriented forward rather than rearward.

1-19. (canceled)

20. An air conveyor, comprising traction means (60) mobile in translation on themselves to drive around a closed loop circuit, pendle arms (3) for suspending sequential loads on the traction means for transporting them along a forward portion of said circuit in a conveyor line going from a loading station where they are individually picked up, each by at least one pendle arm, to an unloading station where they are released therefrom,
wherein said arms (4) are connected to said traction means, in fixed positions regularly distributed along the latter, by articulated assembly devices allowing them, each at a so-called proximal end, to pivot in the vertical plane of the circuit, about an articulation pin perpendicular to said plane,
and wherein means are provided for controlling the orientation of each arm about said articulation pin while its free end executes a complete rotation in space while traveling along said closed loop circuit, between a position in which it is oriented freely hanging vertically at the exit of the unloading station, an intermediate position in which it is tilted toward said traction means when it returns empty backward from the unloading station to the loading station, and a position in which it is again oriented freely hanging vertically on its arrival at the loading station.

21. The air conveyor as claimed in claim 20, applied to the conveyance of sleds sequentially transporting objects such as car bodies in the car industry, said loads then each consisting of a sled carrying such a car body, which is picked up from an upstream conveyor on the ground bringing it via a device such as roller tables (71, 72) to the loading station, and deposited at the unloading station onto another device such as roller tables by which it is taken by a downstream conveyor on the ground.

22. An air conveyor for the conveyance of sleds for sequentially transporting objects such as car bodies in the car industry, comprising traction means (60) associated with motive means controlling their movement in translation on themselves to drive along a closed loop circuit, pendle arms (3) for suspending sleds to transport them along a forward portion of said circuit along a conveyor line going from a loading station where they are individually picked up on an upstream conveyor on the ground upstream, each by at least one pendle arm, to an unloading station where they are released therefrom and deposited onto a downstream conveyor on the ground, wherein said arms (4) are connected to said traction means, in fixed positions regularly distributed along the latter, by articulated assembly devices allowing them, each at a so-called proximal end, to pivot freely in the vertical plane of the circuit, about an articulation pin perpendicular to said plane, and wherein means are provided for guiding a free distal end of each arm, at a distance from its so-called proximal end, on at least a portion of its path during its tilting about said articulation pin between a position in which it is oriented freely hanging vertically at the exit of the unloading station, and a position in which, after having executed a complete rotation in space by rotation relative to the path of the traction means about its articulation pin on the latter, it is again oriented freely hanging vertically on its arrival at the loading station, and supporting members to receive said arms in an intermediate position in which they are tilted along said circuit, in a return portion of said closed loop circuit bringing said arms empty backward from the unloading station to the loading station.

23. The conveyor as claimed in claim 22, wherein said traction means consist of at least one cable (60), also carrying the loads, which is kept tensioned on guide wheels (61, 62, 63) defining its path along said closed loop circuit, said path being horizontal in a return portion thereof bringing the load-suspending arms empty backward from the unloading station to the loading station.

24. The conveyor as claimed in claim 23, wherein said return portion of the closed loop circuit is situated above the forward portion defined by said guide wheels along the conveyor line, and wherein are provided, to control the orientation of the arms (4) about their respective articulation pins on the traction means, supporting members (20) which are secured to said traction means (60) and distributed on the latter in order that each receives one of said arms respectively when it tilts down thereon, by its own weight, when returning empty backward from the unloading station to the loading station.

25. The conveyor as claimed in claim 22, wherein said traction means comprise two similar cables, which are kept tensioned parallel to one another on guide wheels and driven in synchronism along said closed loop circuit, along respective paths defined by guide wheels specific to each either side of said vertical plane, and wherein the two cables are coupled by articulated assembly devices between said arms and said cables, each of these devices being rigidly connected to the two cables of the conveyor at the ends of the articulation pin of the corresponding arm, which thus circulates hanging between the guide wheels of the cables in said forward portion of the closed loop circuit.

26. The conveyor as claimed in claim 25, wherein, to control the orientation of the arms (4) about their respective articulation pins on said cables, support members (20) are provided which are secured to said cables (60) and distributed on the latter so as to each receive one of said arms respectively when it tilts down thereon, by its own weight, when returning empty backward from the unloading station to the loading station, said support members being secured to the two traction carrier cables.

27. The conveyor as claimed in claim 26, wherein each support member (20) is distinct from the articulated assembly device (40) of the pendle arm that it must receive and situated on said traction means sufficiently close to this device, after it in the direction of circulation, to cause an inclination of the arm at the exit of the unloading station, at the passage of a return curve which the path of said traction means comprises to conduct them from the forward circuit portion to the return backward circuit portion, said return portion being situated above said forward portion.

28. The air conveyor as claimed in claim 22, comprising a ramp for retaining the distal end of the pendle arms on the approach to the loading station, to guide a progressive station of each arm about its articulation pin of the assembly device, where the traction means follow a return curve conducting them from the return circuit portion to the forward circuit portion, said return portion being situated above said outward portion.

29. The conveyor as claimed in claim 28, wherein said ramp is formed to conduct each arm into a position inclined rearward on the approach to the loading station until leaving it freely hanging vertically at the loading level.

30. The air conveyor as claimed in claim 22, wherein each arm has at its distal end a hook open rearward in the direction of circulation of the pendle arms to interact with a handle of a sled for transporting the loads with which it engages at the loading station, while the sled is carried more rapidly in a zone of overlap with an upstream conveyor on the ground, and from which it disengages at the unloading station, while the sled is slowed down, if not stopped, on a module of a downstream conveyor on the ground.

31. The conveyor as claimed in claim 30, wherein said traction means consist of at least one cable (60), also carrying the loads, which is kept tensioned on guide wheels (61, 62, 63) defining its path along said closed loop circuit, in which said portion for returning said arms circulating empty from the unloading station to the loading station runs horizontally above said forward conveyor portion, and wherein are provided, on the one hand at the loading station, a ramp for retaining a distal end of each arm at a distance from its proximal end, which guides its swingly rotating about a return curve of the cable which returns it from the return backward portion of the circuit to the forward portion, so as to bring it oriented rearward to release it freely hanging vertically in a position in which its hook is presented in front of a handle interacting with a sled brought by an upstream conveyor on the ground, and means for guiding the tensioned cable thereby causing it to rise in two steps, first to engage the handle by imprisoning it in the hook, then to raise the sled while disengaging it from the upstream conveyor on the ground, and on the other hand, at the unloading station, means for guiding the tensioned cable to lower each arm to a level where the sled first comes to rest on a downstream conveyor on the ground, while the arm reaches a position of disengagement from the handle, from which the arm is lifted freely hanging vertically, and means for causing a progressive inclination of the arm forward when the cable describes a return curve conducting it to said return portion of the circuit, these inclination means advantageously consisting of support members secured to the cable, disposed to receive individually each arm in said intermediate position when it tilts down onto said cable under the effect of its own weight when returning empty backward from the unloading station to the loading station.

32. The conveyor as claimed in claim 31, wherein the arms are rotated by a pivoting movement of each arm at its distal end for substantially a quarter turn at the exit of the unloading station, to pass from the vertical orientation to the intermediate orientation in tilted position on the circuit, and by a reverse rotation movement of each arm, at its distal end relative to said proximal end, of three quarters of a turn on the approach to the loading station.

33. A conveyor installation comprising two symmetrical conveyors as claimed in claim 20, operating in synchronism for the transport of car bodies resting on sleds which are suspended individually on traction carrier cables each by four independent pendle arms.

34. The installation as claimed in claim 33 wherein each of the conveyors comprises two cables circulating in parallel and coupled via articulated assembly devices of the pendle arms.

35. The installation as claimed in claim 34 wherein, along the forward portion of the circuit followed by the cables, the arms are hanging between the respective guide wheels of the two cables defining said closed loop circuit.

36. The installation as claimed in claim 33, wherein the air conveyor overlaps, at the two ends of the installation, with an upstream conveyor on the ground at the loading station on the one hand, with a downstream conveyor on the ground at the unloading station on the other hand, for a length corresponding to the total of two sled modules in the course of transport, where the conveyors on the ground are fitted with means for varying the driving speed of the sleds, in connection with a path of the cables causing the hooks of the pendle arms to descend beneath the interacting handles of the sleds in order to raise them thereafter.

37. An installation comprising two symmetrical conveyors operating in synchronism for the transport of car bodies resting on sleds which are suspended individually on traction means of each conveyor, each by four independent pendle arms, respectively two per conveyor, wherein said traction means consist of cables which are also carriers for the loads suspended thereon by said arms, and wherein said cables are kept tensioned and made to describe by translation on themselves a closed loop circuit situated in a vertical plane and comprising a foward portion of said circuit following a foward conveyor line from a loading station where the sleds with their bodies are individually picked up on an upstream conveyor on the ground to an unloading station where they are released therefrom and deposited on a downstream conveyor on the ground, and a portion for returning the arms circulating empty from the unloading station back to the loading station running above said forward portion, said arms are mounted articulated in fixed positions distributed along said cables by respective assembly devices allowing them, each at a so-called proximal end, to pivot freely in the vertical plane of the circuit, about an articulation pin perpendicular to said plane, so that, on the return portion of the circuit, the pendle arms circulating empty are tilted down, by their own weight, along the cable to which they are assembled, to each rest on an associated support member secured to the latter, each support member is disposed on said cable so as to guide a pivoting of the corresponding arm through a quarter turn at the exit of the unloading station, while pushing it in progressive inclination forward, from a position in which it is freely hanging vertically along the forward portion of the circuit, when the cable describes a return curve conducting it to said return portion of the circuit, and at the loading station, a fixed ramp is provided for retaining the distal end of each arm which guides its tilting, while retaining the arm inclined rearward, when it passes around a return curve which conducts the corresponding cable from the return portion of the circuit to the forward portion, each arm thus passing progressively from its tilted orientation along the circuit in its return portion to a position in which it is again freely hanging vertically at the loading station.

38. The installation as claimed in claim 37, wherein each of the two conveyors comprises two similar cables, which are kept tensioned parallel to one another on guide wheels and driven in synchronism along said closed loop circuit, following respective paths defined by guide wheels specific to each either side of said vertical plane, and wherein a coupling is provided between the two cables of each conveyor, on the one hand, at each pendle arm, by the articulated assembly devices between said arms and said cables, each of these devices being rigidly connected to the two cables of the conveyor by grips clamped onto the cables at the opposite ends of the articulation pin of the corresponding arm, which circulates thus hanging between the respective guide wheels of the cables in said forward portion of the closed loop circuit, on the other hand, at the various support members, the latter interacting by rolling contact each with the arm which precedes it, between two grips for attaching to the two cables respectively.
